(19) United States
(12) Patent Application Publication
(10) Pub. No.: US 2015/0293888 A1
(43) Pub. Date: Oct. 15, 2015

(54) Expandable Application Representation, Milestones, and Storylines

(71) Applicant: Microsoft Corporation, Redmond, WA (US)

(72) Inventor: Jiawei Gu, Beijing (CN)

(21) Appl. No.: 14/517,417

(22) Filed: Oct. 17, 2014

(30) Foreign Application Priority Data
Apr. 11, 2014 (CN) PCT/CN2014/075180

(51) Int. Cl. G06F 17/21; G06F 3/0484

(52) U.S. Cl. CPC G06F 17/212; G06F 3/04842

(57) ABSTRACT

Expandable application representation, milestone, and storyline techniques are described. The techniques may include support of an expandable representation that may function as an intermediary within a root level (e.g., start menu or screen) of a file system. Milestone techniques are also described, which may leverage the expanded representation and other display techniques. A user, for instance, may specify a milestone that is to cause output of an application, such as a sports score, join point in an online game, and so on. Additionally, storyline techniques are described in which a previous version of a game may be utilized to provide context during the loading of a subsequent version of the game

### PRIORITY APPLICATION

This application claims benefit of priority of PCT Application Serial No. PCT/CN2014/075180 entitled “Expandable Application Representation, Milestones, and Storylines” filed Apr. 11, 2014, the content of which is incorporated by reference herein in its entirety.

### BACKGROUND

With the advent of application availability via the Internet, the number of applications that are made available to a user has increased along with the ease at which the user may access these applications. Accordingly, users may chose and install a large number of applications on the users' computing device.

However, interaction by a user with the applications may be hindered by the number of applications that are installed on the computing device. This may include locating an application of interest as well as accessing functionality of the application. For instance, a user may select a weather application to get weather information, then interact with a news application to catch up on the latest news, and so on through a number of other applications. Consequently, navigation through these applications to locate desired information may take a significant amount of time, which may be further complicated by the number of applications that are available on the computing device.

### SUMMARY

Expandable application representation, milestone, and storyline techniques are described. The techniques may include support of an expandable representation that may function as an intermediary within a root level (e.g., start menu or screen) of a file system. The expandable representation, for instance, may be output via a gesture to gain additional information that was not included in an unexpanded version of the representation, may be utilized to provide inputs to an application, and so on. Thus, this may support non-modal interaction by a user within the root level of the file system.

Milestone techniques are also described, which may leverage the expanded representation and other display techniques. A user, for instance, may specify a milestone that is to cause output of an application, such as a sports score, join point in a multiplayer game, and so on. Additionally, storyline techniques are described in which a previous version of a game may be utilized to provide context during the loading of a subsequent version of the game. Further description of these and other examples involving and not involving an expandable representation are also contemplated as further described in the detail description.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 depicts an environment in an example implementation that is configured to perform expandable representation techniques described herein.

FIG. 2 depicts an example implementation showing a plurality of display modes that are usable to support user interaction with an application.

FIG. 3 depicts an example implementation showing use of a gesture to cause output of an expanded representation that involves an animation.

FIG. 4 depicts an expanded representation that is output responsive to a gesture of FIG. 3 that is configured to include preview functionality.

FIG. 5 depicts an example implementation showing another instance of user interaction with an expanded representation and corresponding preview functionality.

FIG. 6 is an illustration of an environment in an example implementation that is operable to support desktop and immersive shells of the operating system of FIG. 1.

FIG. 7 depicts a system in an example implementation in which an expanded representation is included in a taskbar configured as a back stack of the operating system of FIG. 1.

FIG. 8 is an example implementation showing the expanded representation of FIG. 7 in greater detail.

FIG. 9 depicts an example implementation of an expanded representation of a desktop shell of FIG. 6 usable to display previews of content.

FIG. 10 is an example implementation showing representations and expanded representations of news and contact applications that are usable to display previews of content.

FIG. 11 depicts a system in an example implementation in which a milestone module of FIG. 1 outputs a user interface configured to accept user inputs to set milestones for applications.

FIG. 12 depicts an example implementation in which a predefined milestone is detected to cause output of an application.

FIG. 13 depicts an example implementation in which milestone expanded representations are utilized to represent particular points in time and include previews for a game that are selectable to launch the game at the previewed point in time.

FIG. 14 depicts an example implementation in which a storyline is linked between a plurality of applications.

FIG. 15 is a flow diagram depicting a procedure in an example implementation in which a representation is expanded in a root level of a file hierarchy of an operating system and used to provide a preview.

FIG. 16 is a flow diagram depicting a procedure in an example implementation in which a milestone is defined by a user and utilized to control output of an application.

FIG. 17 is a flow diagram depicting a procedure in an example implementation in which a link of a storyline between a plurality of applications is leveraged in loading at least one of the applications.

FIG. 18 illustrates various components of an example device that can be implemented as any type of computing device as described with reference to FIGS. 1-17 to implement embodiments of the techniques described herein.

### DETAILED DESCRIPTION

Overview

Representations of applications (e.g., icons, tiles, and so on) may be utilized to support a wide variety of functionality without having the user specifically launch the application. For example, a representation of a weather application may include a notification that describes current weather conditions. However, conventional techniques that were utilized to display a notification were often static and modal and thus often necessitated that a user navigate away from the representations to gain further information about the notification.

Expandable application representation techniques are described. The techniques may include support of an expandable representation (e.g., tile) that may function as an intermediary within a root level (e.g., start screen) of a file system. For example, the root level may include representations, such as tiles, of applications within a start menu.

Milestone techniques are also described which may leverage the expanded representation and other display techniques. A user, for instance, may specify a milestone that is to cause output of an application, such as a sports score, join point in a multiplayer game, and so on. Upon reaching the milestone, the application may be output automatically and without user intervention. This may be performed through use of the expanded representation, a full-screen view, a snapped view, and so on as further described below.

Additionally, storyline techniques are described in which a previous version of a game may be utilized to provide context during the loading of a subsequent version of the game. For example, a user may desire to play a game and therefore initiate loading of the game by a computing device, e.g., a game console. While the game is being loaded, a corresponding portion of a previous version of the game may be output to give context to a particular point in time in a storyline of the loading game. In this way, developers may provide continuity between different versions of a game. Further description of these and other techniques may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

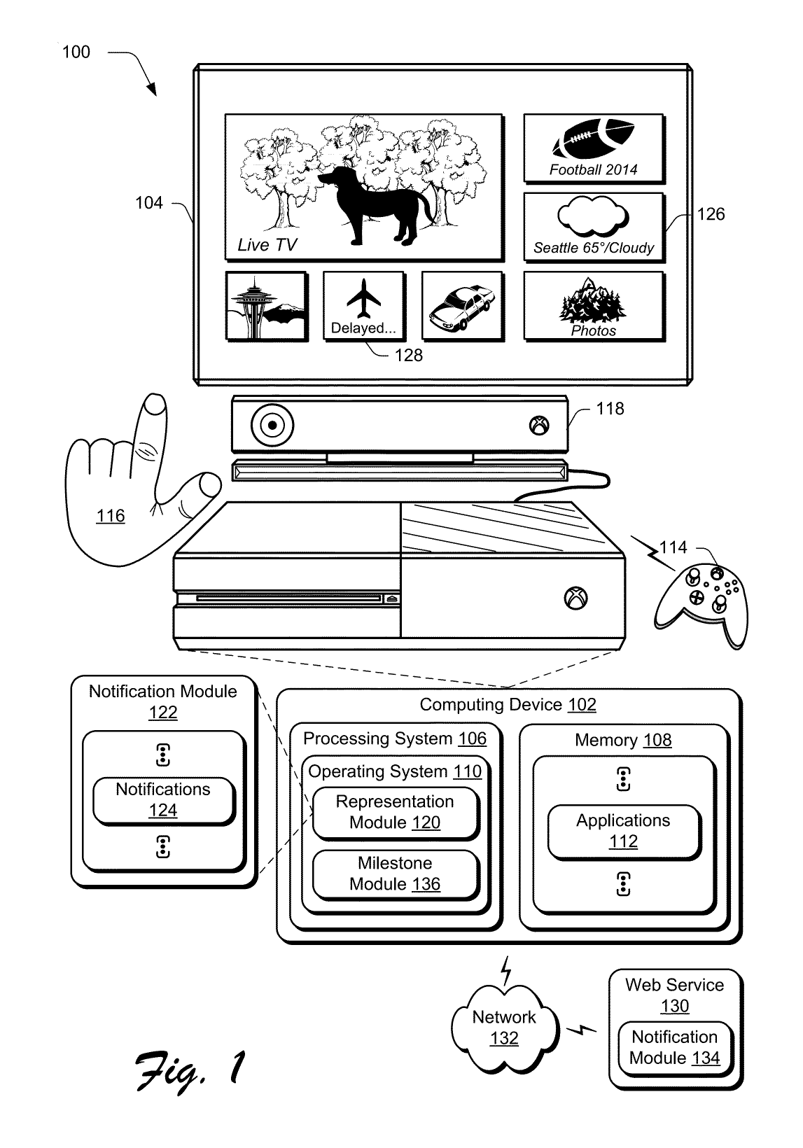

FIG. 1 is an illustration of an environment 100 in an example implementation that is operable to employ the menu techniques described herein. The illustrated environment 100 includes an example of a computing device 102, which is illustrated as a game console that is communicatively coupled to a display device 104 (e.g., a television) but may be configured in a variety of other ways. For example, the computing device 102 may be configured as a traditional computer (e.g., a desktop personal computer, laptop computer, and so on), a mobile station, an entertainment appliance, a wireless phone, a tablet, a netbook, and so forth as further described in relation to FIG. 18. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is also illustrated as including a processing system 106 and an example of computer-readable storage media, which in this instance is memory 108. The processing system 106 is not limited by the materials from which it is formed or the processing mechanisms employed therein. For example, the processing system 106 may be comprised of semiconductor(s) and/or transistors (e.g., electronic integrated circuits (ICs)), such as a system on a chip, processors, central processing units, processing cores, functional blocks, and so on. In such a context, executable instructions may be electronically-executable instructions. Alternatively, the mechanisms of or for processing system 106, and thus of or for a computing device, may include, but are not limited to, quantum computing, optical computing, mechanical computing (e.g., using nanotechnology), and so forth. Additionally, although a single memory 108 is shown, a wide variety of types and combinations of memory may be employed, such as random access memory (RAM), hard disk memory, removable medium memory, and other types of computer-readable media.

The computing device 102 is further illustrated as including an operating system 110. The operating system 110 is configured to abstract underlying functionality of the computing device 102 to applications 112 that are executable on the computing device 102. For example, the operating system 110 may abstract the processing system 106, memory 108, network, input/output, and/or display functionality of the computing device 102 such that the applications 112 may be written without knowing “how” this underlying functionality is implemented. The application 112, for instance, may provide data to the operating system 110 to be rendered and displayed by the display device 104 without understanding how this rendering will be performed. The operating system 110 may also represent a variety of other functionality, such as to manage a file system and user interface that is navigable by a user of the computing device 102.

The operating system 110 may be configured to process a variety of different input/output functionality supported by the computing device 102. Thus, the operating system 110 include functionality relating to recognition of inputs and/or provision of outputs by the computing device 102. For example, the operating system 110 may be configured to identify gestures and cause operations to be performed that correspond to the gestures, and so on. The inputs may be detected for processing by the operating system 110 in a variety of different ways.

For example, the operating system 110 may be configured to receive one or more inputs via touch interaction with a hardware device, such as a controller 114 as illustrated. Touch interaction may involve pressing a button, moving a joystick, movement across a track pad, use of a touch screen of the display device 104 (e.g., detection of a finger of a user's hand 116 or a stylus), and so on. Recognition of the touch inputs may be leveraged by the operating system 110 to interact with a user interface output by the computing device 102, such as to interact with a game, an application, browse the internet, change one or more settings of the computing device 102, and so forth. A variety of other hardware devices are also contemplated that involve touch interaction with the device. Examples of such hardware devices include a cursor control device (e.g., a mouse), a remote control (e.g. a television remote control), a mobile communication device (e.g., a wireless phone configured to control one or more operations of the computing device 102), and other devices that involve touch on the part of a user or object.

The operating system 110 may also be configured to support a natural user interface (NUI) that may recognize interactions that may not involve touch. For example, the computing device 102 may include a NUI input device 118. The NUI input device 118 may be configured in a variety of ways to detect inputs without having a user touch a particular device, such as to recognize audio inputs through use of a microphone. For instance, the NUI input device 118 may be configured to support voice recognition to recognize particular utterances (e.g., a spoken command) as well as to recognize a particular user that provided the utterances.

In another example, the NUI input device 118 may be configured to support recognition of gestures, presented objects, images, and so on through use of a camera. The camera, for instance, may be configured to include multiple lenses so that different perspectives may be captured and thus determine depth. The different perspectives, for instance, may be used to determine a relative distance from the NUI input device 118 and thus a change in the relative distance.

In another example, a time-of-flight camera may be utilized to determine relative distances of objects, e.g., arms, hands, fingers, legs, torso, and head of a user. For instance, the NUI input device 118 may capture images that are analyzed by the operating system 110 to recognize one or more motions made by a user, including what body part is used to make the motion as well as which user made the motion. An example is illustrated through recognition of positioning and movement of one or more fingers of a user's hand 116 and/or movement of the user's hand 116 as a whole. The motions may be identified as gestures by the NUI input device 118 to initiate a corresponding functions. Thus, the NUI input device 118 may be leveraged to support depth perception in a variety of different ways. The images captured by the NUI input device 118 may be leveraged to provide a variety of other functionality, such as techniques to identify particular users (e.g., through facial recognition), objects, and so on.

A variety of different types of gestures may be recognized, such a gestures that are recognized from a single type of input (e.g., a motion gesture) as well as gestures involving multiple types of inputs, e.g., a motion gesture and an object gesture made using an object such as a stylus. Thus, the NUI input device 118 may support a variety of different gesture techniques by recognizing and leveraging a division between inputs. It should be noted that by differentiating between inputs in the natural user interface (NUI), the number of gestures that are made possible by each of these inputs alone is also increased. For example, although the movements may be the same, different gestures (or different parameters to analogous commands) be indicated using different types of inputs. Thus, the NUI input device 118 may support a natural user interface that supports a variety of user interaction's that do not involve touch.

Accordingly, although the following discussion may describe specific examples of inputs, in instances different types of inputs may also be used without departing from the spirit and scope thereof. Further, although in instances in the following discussion the gestures are illustrated as being input using a NUI, the gestures may be input using a variety of different techniques by a variety of different devices, such as to employ touchscreen functionality of a tablet computer. Other non-gesture techniques are also contemplated, such as to select one or more buttons of the controller 114.

The operating system 110 may also represent a variety of other functionality, such as to manage a file system and a user interface that is navigable by a user of the computing device 102. An example of this is illustrated as an application launcher (e.g., start screen) that is displayed on the display device 104 of the computing device 102. The start screen includes representations of a plurality of the applications 112, such as icon, tiles, textual descriptions, and so on. The start screen may be considered a root level of a hierarchical file structure, e.g., each of the other levels are “beneath” the root level in the hierarchy. The representations shown in the illustrated example are selectable to launch a corresponding one of applications 112 for execution on the computing device 102. In this way, a user may readily navigate through a file structure and initiate execution of applications of interest.

The operating system 110 is also illustrated as including a representation module 120. The representation module 120 is representative of functionality to manage representations of applications 112 (e.g., tiles, icons, and so on) and content consumable by the applications 112, examples of which are illustrated for the start screen. In some instance, the representations may include notifications that may be displayed as part of the representations without launching the represented applications 112. This functionality is illustrated as a notification module 122 that is configured to manage notifications 124 for inclusion as part of the representations.

For example, a representation 126 of a weather application is illustrated as including a notification that indicates a name and current weather conditions, e.g., “Seattle 65°/Cloudy.” Likewise, a representation 128 for a travel application is illustrated as including a notification that indicates that a current flight status is “delayed.” In this way, a user may readily view information relating to the applications 112 without having to launch and navigate through each of the applications. Although representations of specific applications are shown, other representations of applications are also contemplated, such as a representation of an application that references a user's involvement with a service, e.g., a friend in a social network service.

In one or more implementations, the notifications 124 may be managed without executing the corresponding applications 112. For example, the notification module 122 may receive the notifications 124 from a variety of different sources, such as from software (e.g., other applications executed by the computing device 102), from a web service 130 via a network 132, and so on. This may be performed responsive to registration of the applications 112 with the notification module 122 to specify where and how notifications are to be received. The notification module 122 may then manage how the notifications 124 are displayed as part of the representations without executing the applications 112. This may be used to improve battery life and performance of the computing device 102 by not running each of the applications 112 to output the notifications 124.

Although this discussion described incorporation of the notification module 122 at the client, functionality of the notification module 122 may be implemented in a variety of ways. For example, functionality of a notification module 134 may be incorporated by the web service 130 in whole or in part. The notification module 134, for instance, may process notifications received from other web services and manage the notifications for distribution to the computing device 102 over the network 132.

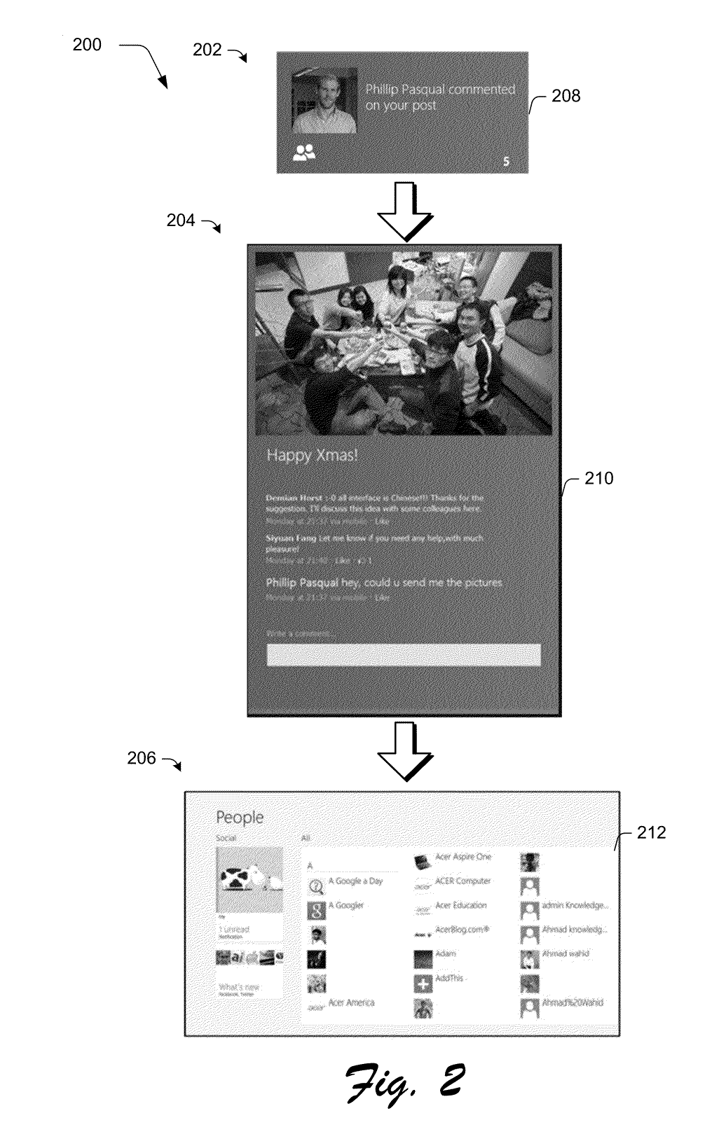

As previously described, conventional techniques were often modal and thus caused a user to navigate away from the root level to gain more information. For example, a user may view the representation 126 of the weather application is illustrated as including a notification that indicates a name and current weather conditions, e.g., “Seattle 65°/Cloudy.” To gain additional information, the user selected the representation 126 to launch a corresponding application, which causes the user to leave the start menu in this example. However, techniques are described in which the representations may be expanded within the root level to support additional functionality without causing the user to navigate away from the root level and thus support non-modal interaction, an example of which is described in relation to FIG. 2.

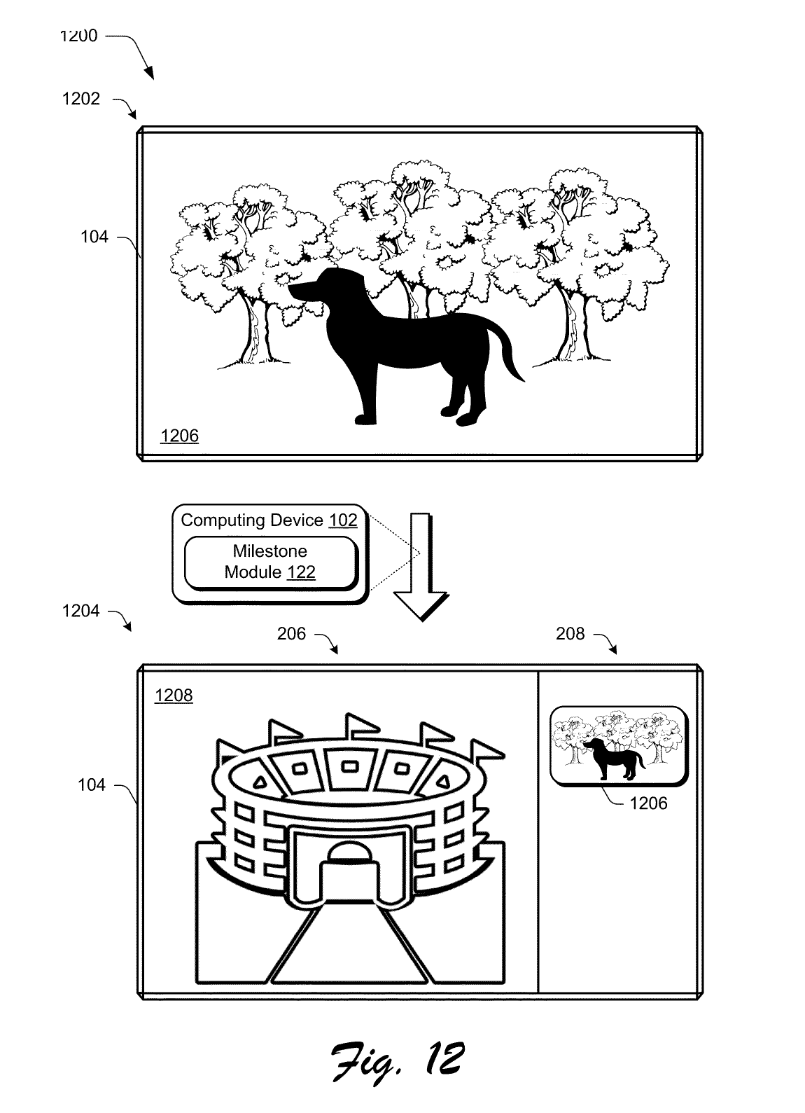

The operating system 110 is also illustrated as including a milestone module 136. The milestone module 136 is representative of functionality to enable a user or application developer to specify milestones to cause output of applications 112. A user, for instance, may specify a milestone that is to cause output of an application, such as a sports score, join point in a multiplayer game, and so on. Upon reaching the milestone, the application may be output automatically and without user intervention. This may be performed through use of the expanded representation, a full-screen view, a snapped view, and so on as further described in relation to FIGS. 11-13.

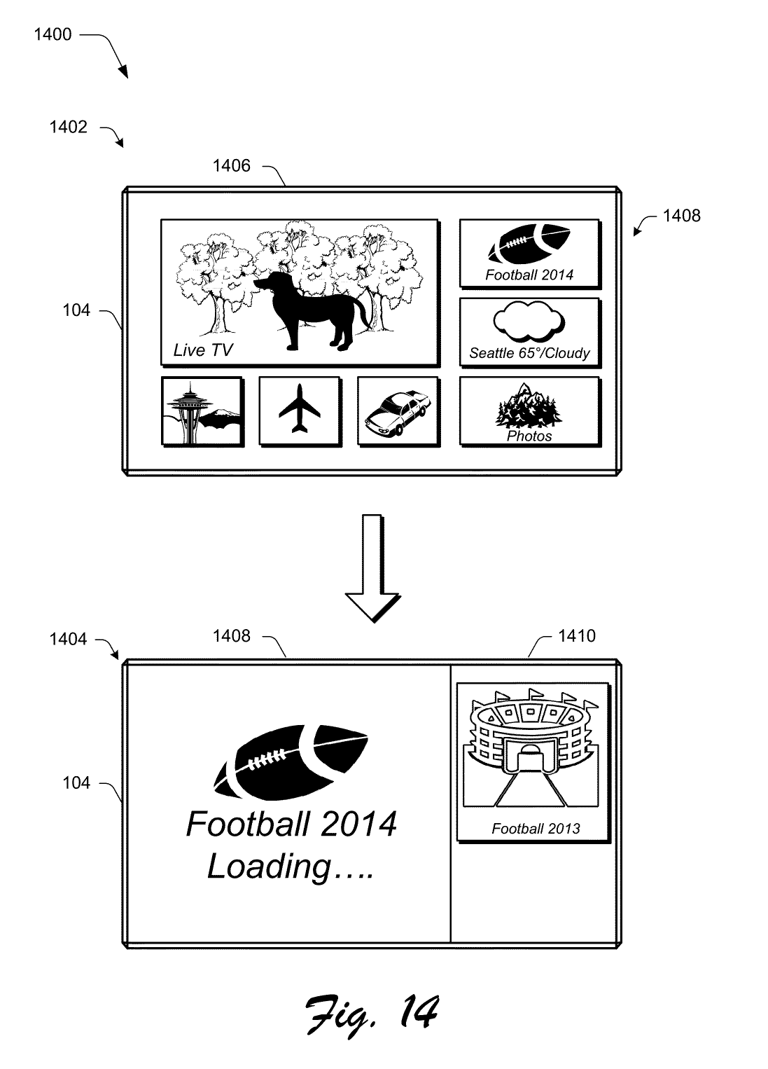

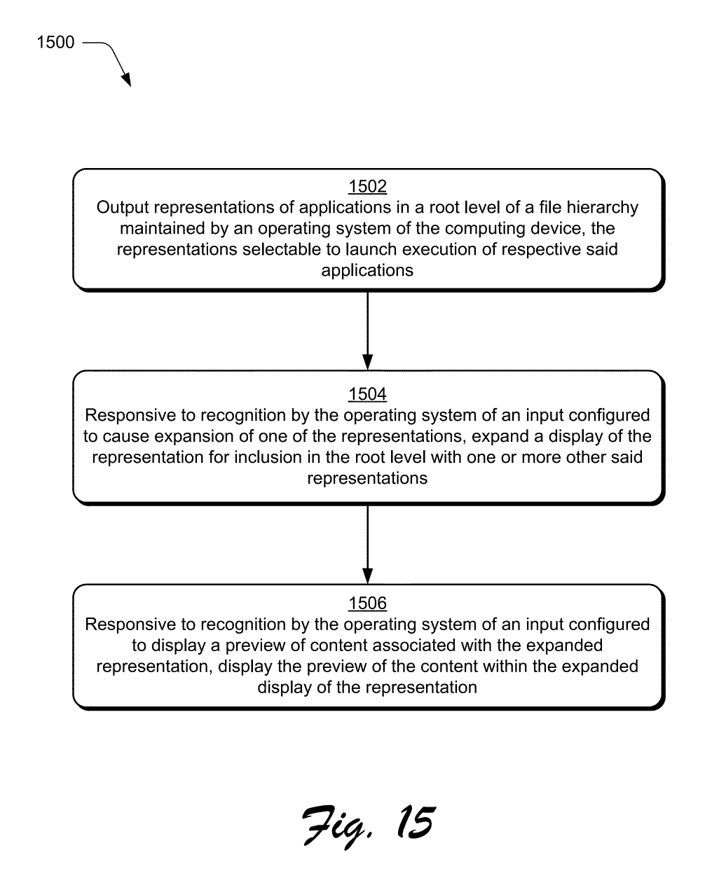

In another example, the milestone module 136 may support milestones to link execution of applications to each other. For example, the milestones may be utilized to link storylines between different versions of a game. For example, a user may desire to play a game and therefore initiate loading of the game by a computing device, e.g., a game console. While the game is being loaded, a corresponding portion of a previous version of the game may be output to give context to a particular point in time in a storyline of the loading game. In this way, developers may provide continuity between different versions of a game. Further description storylines may be found in relation to FIG. 14.

FIG. 2 depicts an example implementation 200 showing a plurality of display modes that are usable to support user interaction with an application. The example implementation is illustrated through use of first, second, and third display modes 202, 204, 206 for interaction with an application and associated content. In the first display mode 202, a representation 208 is configured as a tile corresponding to a contact that also includes a notification that the contact commented on the post of the user. To view additional information about this notification, a user may supply an input (e.g., gesture, selection via a cursor control device, speech input, and so on) to cause expansion of the representation 208 to transition to the second display mode 204.

In the second display mode 204, an expanded representation 210 is shown that is output responsive to the gesture or other input described above. The expanded representation 210 includes additional content related to the notification in this example. For instance, the expanded representation 210 includes a picture that was the subject of the post, other comments made in relation to the post, an input portion configured to receive one or more inputs from a user of the computing device 104 (e.g., text inputs, selection of buttons, and so on in this example), as well as the post that was actually made by a user represented by the contact. Thus, the representation 210 includes additional content other than the notifications included in the unexpanded representation 208, which may further describe the notification. In other examples, multiple additional notifications may be displayed. The second display mode 204 may have a plurality of different sub-modes involving display of the expanded representation.

The expanded representation 210 may be configured to receive and output this content in a variety of ways. For example, selection of the representation 208 to cause output of the expanded representation 210 may cause execution of a corresponding application 112 of FIG. 1. Thus, in this example the application 112 is “woken” to obtain the content for inclusion in the expanded representation 210.

In another example, the content of display 204 may be supplied by the notification module 122 of FIG. 1 without executing the corresponding application 112. For example, the notification module 122 may be configured to obtain notifications as previously described in relation to FIG. 1 without executing the applications 112. In this way, the notification module 122 may obtain content associated with the application 112 to support user interaction with the application 112 without actually executing the application.

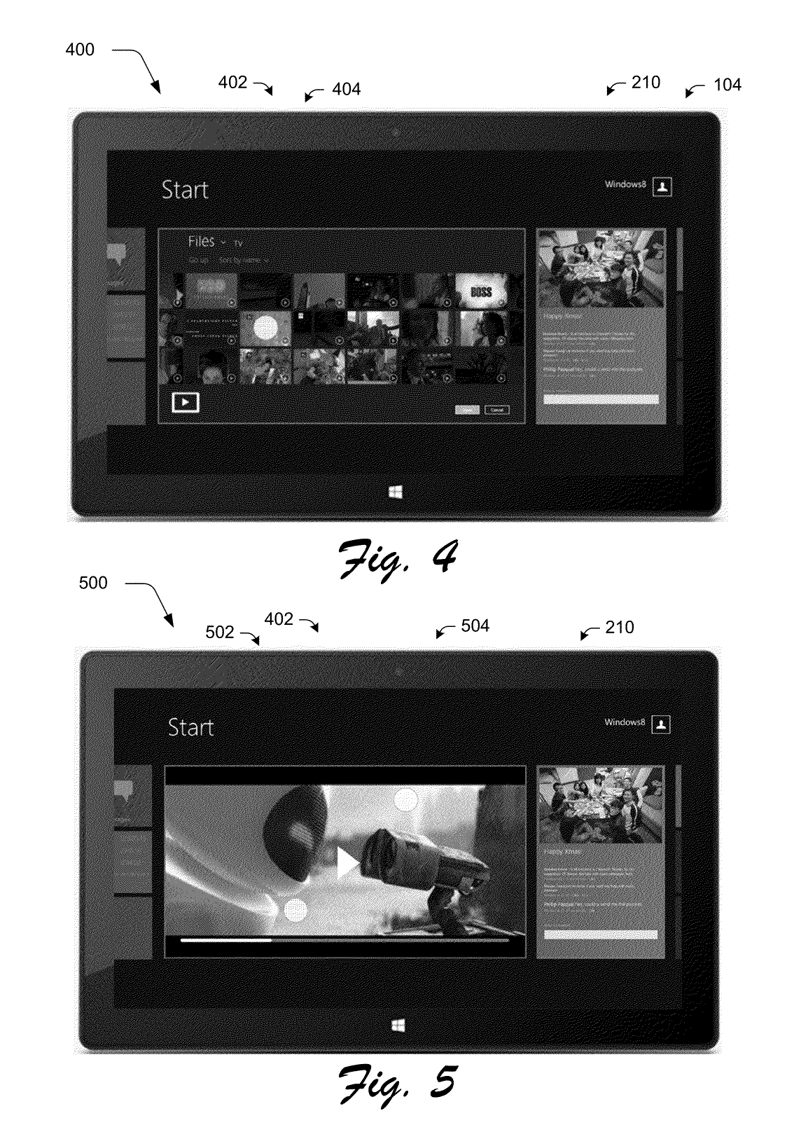

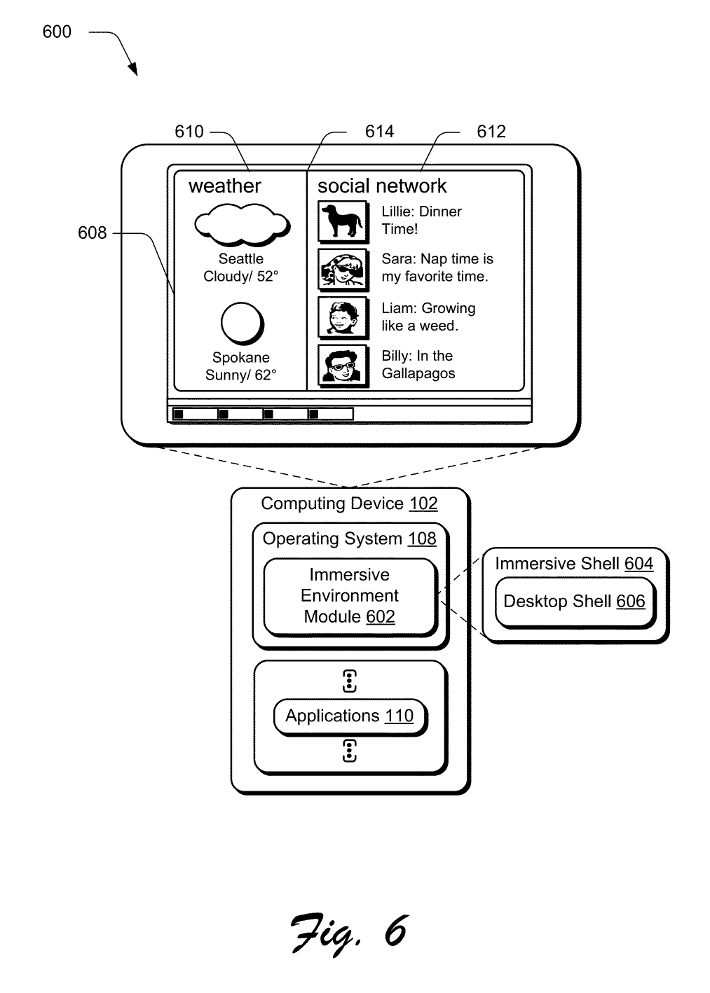

The second display mode 204 may also support a variety of different sub-modes involving display of the expanded representation. For example, one such sub-mode may involve an expanded representation that may be utilized to provide additional content, such as additional notifications or additional content associated with a particular notification, view activity levels of content in a shared network environment, and so on. Another expended representation in another sub-mode may be utilized to allow a user to provide limited inputs to an application and/or allow limited functionality to applications features such as making a call, answering a text, post a status, play a video or song, and so forth. Another expanded representation in another one of the sub-modes of the application at a root level mode may include a full functionality implementation of the app within the larger root mode display, such as a calculator, Sudoku game, video player as shown in FIGS. 4 and 5, and so on which is described in further detail below.

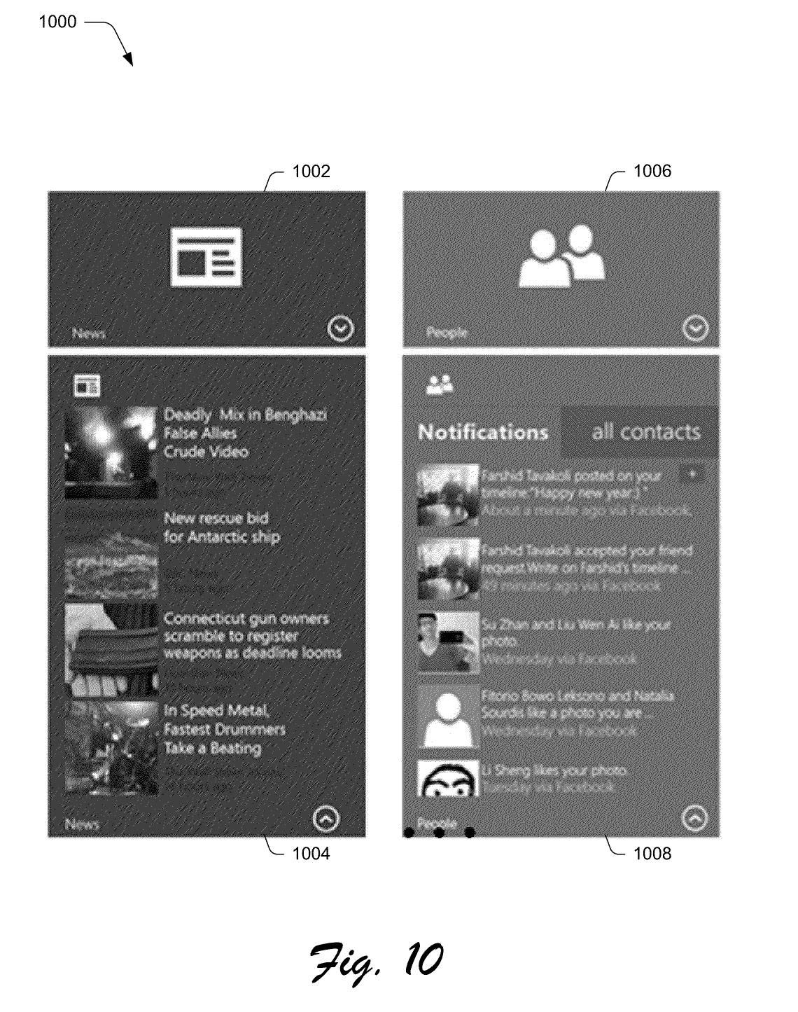

In the third display mode 206, execution of the application 112 associated with the representation (e.g., a contacts application) is fully launched in a mode such as desktop mode in a window or frame or in a full screen view or split screen without chrome. For example, the operating system 110 may support an immersive shell as further described in relation to FIG. 9 in which an application is displayed without chrome, e.g., without a window. The third display mode 206 may be entered through selection of either the representation 208 in the first display mode 202 or the expanded representation 210 in the second display mode 204 or through any other suitable icon or user interaction with the application representation.

Thus, although not an expanded presentation of an application, the next expansion provided via the third display mode involves launching of the application to the typical full screen or split screen application running within a full screen or window frame in a desktop. Thus, all the expanded representations of the application within the root mode display this may support non-modal interaction by a user without forcing the user to navigate “away” from the root level.

Further, a user may navigate between the modes in a variety of ways. For example, a user may select a portion of the representation 208 (e.g., the text of the notification) to cause output of the expanded representation 210 and select another portion of the representation 208 (e.g., the shadowed people representing a contacts application) to cause a transition to the third display mode 206. Gestures may also be supported, an example of which is described as follows and shown in the corresponding figure.

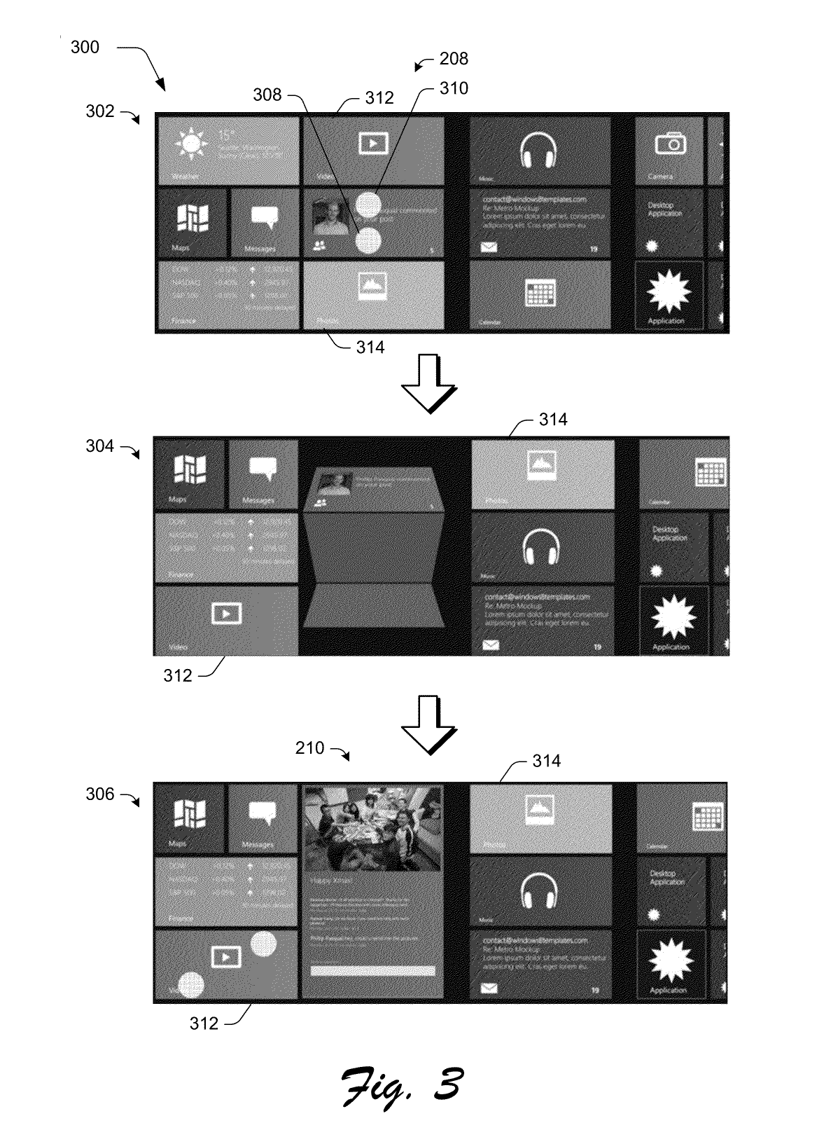

FIG. 3 depicts an example implementation 300 showing use of a gesture or icon (down arrow, etc.) to expand to the next hierarchical view or representation and selection of another portion of the application representation (icon, tile, etc.) may open the fully functioning application. In some cases, the input received by the operating system associated with expanding the application representation will cause output of an expanded representation that involves an animation. This example implementation 300 is shown using first, second, and third 302, 304, 306 stages. At the first stage 302, a user contacts the representation 208 as shown in FIG. 2 using two fingers (illustrated through use of two phantom circles 308, 310) and moves them apart to make an expansion gesture. Other gestures are also contemplated, such as a tap or activation through a menu or icon. As illustrated, the start screen in this example includes a plurality of other representations configured as tiles that follows a grid arrangement.

The operating system 110 then recognizes the gesture and in response causes output of an animation or other suitable user interface display transformation as shown in the second stage 304. In the displayed embodiment, the animation in this example gives an appearance that the representation 208 shown in second stage 304 is unfolding to assume its expanded size. It should also be recognized in this stage that the animation also involves rearrangement of other representations. As illustrated, the representation 208 is included in a column that includes representations 312, 314 of video and photos in the first stage 302. The representations 312, 314 of video and photos are then moved to adjacent columns in the second stage 304, e.g., the video representation 312 to the left and the photos representation 314 to the right. This movement may also cause rearrangement of other columns as illustrated. Any appropriate movement of proximate application representations may be used to make room for expanding the representation of the selected application representation in the root mode.

At the third stage 306, the expanded representation 210 is shown along with the other rearranged representations. In this way, a user may interact with the expanded representation 210 in a non-modal manner without leaving the root level, e.g., the start screen, of the operating system 110 in this example. Although a root level is described, it should be readily apparent that this functionality may also be employed at other levels in a file system without departing from the spirit and scope thereof, such as in a taskbar.

Use of expanded representations may also be leveraged to support multitasking. For example, as shown in the third stage 306, a user repeats the expansion gesture as previously described, but in this instance performs the gesture for the representation 312 of a video application. This also causes expansion of the representation and rearrangement of other representations as shown in the example implementation 400 of FIG. 4.

In FIG. 4, an expanded representation 402 is illustrated that is output responsive to the gesture of FIG. 3. The expanded representation 402 for the video application is displayed concurrently with the expanded representation 210 for the contacts application. The expanded representation 402 includes content that is selectable via the representation and in some implementations to cause display of the video within the representation within the root mode.

In this way, the expanded representations 210, 402 may permit a user to multitask by interacting with a plurality of expanded representations simultaneously, e.g., to watch a video and view posts from a social network service and also allow the panning/scrolling or other root mode user interactions with the root mode display of multiple application representations. Thus, in this example the expanded representation 402 supports inputs to interact with content displayed within the tile. An expanded representation may also be configured to support text inputs as shown for expanded representation 210.

The expanded representation 402 may also include functionality to enable a user to preview content consumable by a represented application 112. For example, the expanded representation 402 includes a plurality of content (e.g., videos) that is consumable via a video application as described above. A user may then provide an input (e.g., via a “hover” in which a finger of the user's hand 116 is disposed proximal to the display device 104 but does not touch the device, a gesture detected via a NUI input device 118, and so on) to cause output of a preview of a particular one of a plurality of different items of content. In response, the content may be rendered for output “as is” with other content representations in the expanded representation 210.

In another example, a user may select the particular item via a tap 404 as illustrated by the phantom circle. The operating system 110 may then recognize this input to cause the content to take over display in the expanded representation 402 as shown in the example implementation of FIG. 5. In this example, the content is displayed within the root level of the file system in the second display mode and thus still supports multitasking, such as to interact with the expanded representation 210 of the contact. A user, once viewing the preview, may then decide to view the content in the third display mode for a full screen experience. This may be performed in a variety of ways. The user, for instance, may contact the representation 402 as shown in FIG. 2 using two fingers (illustrated through use of two phantom circles 502, 504) and move them apart to make an expansion gesture. Other gestures are also contemplated, such as a tap or activation through a menu or icon as previously described. Although use of a preview in an expanded representation was described for interaction at a root level of a file management system, these techniques may also be employed using a taskbar, an example of which is described as follows and shown in a corresponding figure.

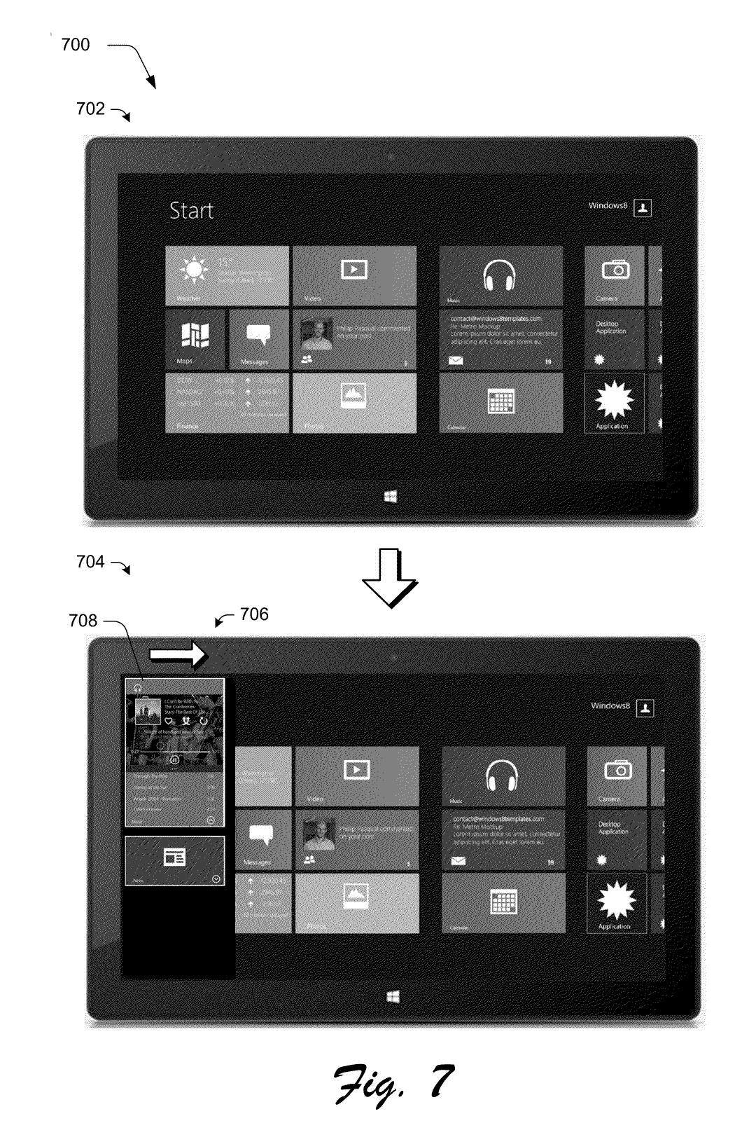

FIG. 6 is an illustration of an environment 600 in an example implementation that is operable to support desktop and immersive shells of the operating system 110. The illustrated environment 600 includes a computing device 102 in a slate form factor having the operating system 110 and application 112 as previously described in relation to FIG. 1.

The operating system 110 is also illustrated as including an immersive environment module 602 that is representative of functionality of the computing device 102 to provide an immersive shell 604 via which a user may interact with the applications 112 and other data of the computing device 102, both local to the device as well as remotely via a network. The immersive shell 604 is configured to accept inputs to interact with the operating system 110 and applications 112 of the computing device 102 to access functionality of the computing device 102, such as the abstracted functionality described above. The immersive shell 604 may also be configured to support a desktop shell 606 as further described below.

The immersive shell 604 may be configured to support interaction with the applications 112 with little to no window frame. Additionally, the immersive shell 604 may support interaction with the applications 112 without requiring the user to manage a corresponding window frame's layout, primacy of the window with respect to other windows (e.g., whether a window is active, in front of behind other windows, an order of the windows, and so on). Although illustrated as part of the operating system 110, the immersive environment module 602 may be implemented in a variety of other ways, such as a stand-alone module, remotely via a network, and so forth.

In one or more implementations, the immersive shell 604 of the operating system 110 is configured such that it is not closeable or capable of being uninstalled apart from the operating system 110. Additionally, the immersive shell 604 may be configured to consume a significant portion of an available display area of a display device 608 of the computing device 104. A user may interact with the immersive shell 604 in a variety of ways, such as via a cursor control device, using one or more gestures, using speech recognition, capture using one or more depth-sensing cameras, and so on.

Thus, the immersive environment module 602 may manage the immersive shell 116 in which content of applications 112 may be presented and the presentation may be performed without requiring a user to manage size, location, primacy, and so on of windows used to display the content of the applications 112.

For example, as shown on a user interface displayed by the display device 608, a user interface is shown that is configured to display data 610, 612 from two applications in a “snapped” configuration. In this example, both of the applications that correspond to the data are enabled to actively execute by the computing device 102 while execution is suspended for other of the applications 112 that do not currently display data. A gutter 614 is disposed between the displays of the data 610, 612 that may be moveable to change an amount of display area consumed by applications on the display device 608, respectively.

The immersive shell 604 may support a wide variety of functionality to provide an immersive experience for a user to access the applications 112. In the following discussion, this functionality is discussed in relation to leveraging these techniques to enable interaction with a desktop shell 606. It should be readily apparent, however, that these techniques may be employed for managing interaction with the applications 112 themselves without departing from the spirit and scope thereof

The desktop shell 606 is representative of another configuration of a user interface output by the operating system 110 when in this example is to interact with the applications 112 and other data. For example, the desktop shell 606 may be configured to present applications and corresponding data through windows having frames. These frames may provide controls through which a user may interact with an application as well as controls enabling a user to move and size the window. The desktop shell 606 may also support techniques to navigate through a hierarchical file structure through the use of folders and represent the data and applications through use of icons. In one or more implementations, the desktop shell 606 may also be utilized to access applications 112 that are configured specifically for interaction via the desktop shell 606 and not configured for access via the immersive shell 604, although other implementations are also contemplated.

In one or more of the techniques described herein, the immersive shell 604 provides access to the desktop shell 606 as if the desktop shell 606 was another application that was executed on the computing device 104. In this way, a user may utilize the functionality of the immersive shell 604 yet still access the desktop shell 606 for more traditional functionality. Examples of implementation of the desktop as an immersive application within the immersive shell include use of the expandable representation techniques described herein which is described as follows and shown in a corresponding figure.

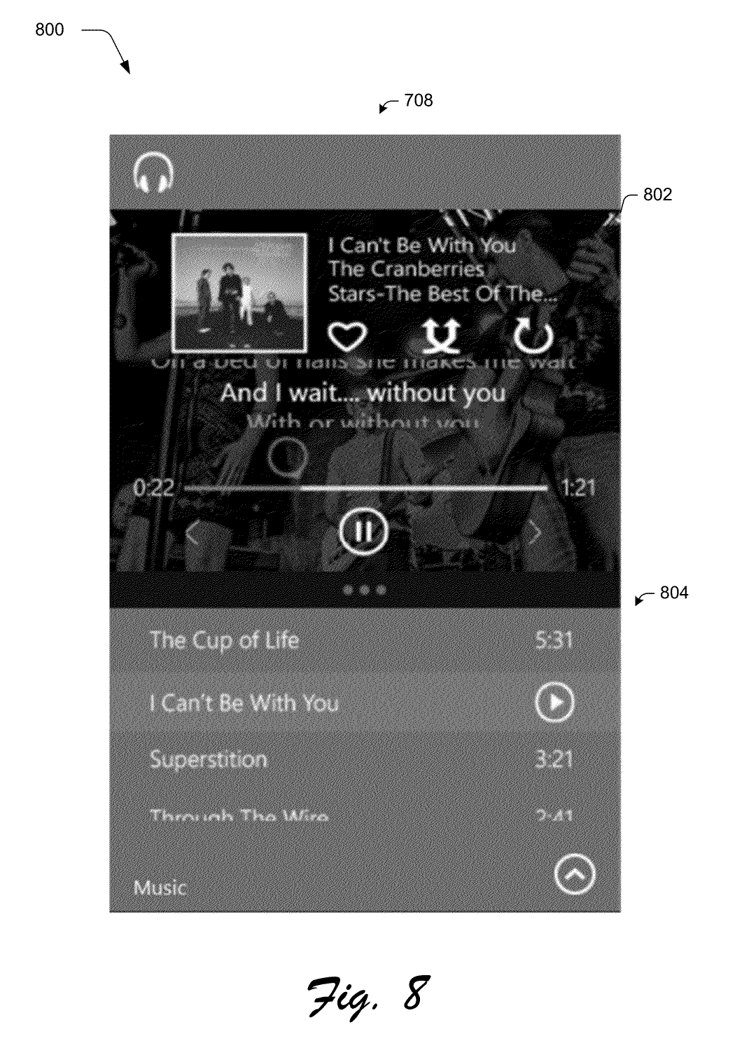

FIG. 7 depicts a system 700 in an example implementation in which the expanded representation is included in a taskbar configured as a back stack of the operating system 110 of FIG. 1. The system 700 is illustrated using first and second stages 702, 704. The first stage 702 shows a start screen that is one example of a root level of a file system as previously described.

As previously described in relation to FIG. 6, the operating system 110 may maintain an immersive environment in which a display of one or more applications may substantially consume a display environment of one or more display devices. However, applications may also “remain available” by the operating system 110 through use of a taskbar 706 operating as a “back stack” in which execution of the application is suspended until it appears on the display device 608. A user, for instance, may make a swipe gesture through one or more fingers of the user's hand (which is illustrated through use of an arrow in the illustration), a “click and drag” gesture, and so on to replace one or more of the applications currently being displayed with an application from the back stack. Other examples are also contemplated in which the taskbar 706 is not associated with “back stack” functionality, e.g., the applications represented in the taskbar are actively executing, were “pinned” to the taskbar, and so on.

In the illustrated example, the taskbar 706 includes representations that are selectable to navigate to user interfaces of the applications, e.g., to a third display state “full screen” view in an immersive shell. The representations in the taskbar also include an expanded representation as previously described, which in this instance is an expanded representation for a photo application. The expanded representation may be included in the taskbar in a variety of different ways. For example, the photo application may be in a suspended state in a back stack and thus included automatically and without user intervention through selection of execution of the application. The expanded representation may also be “pinned” to the taskbar using one or more commands by a user (e.g., a “right click” menu), and so on.

The taskbar 706 may be accessed in a variety of different scenarios. For example, a user may view the start screen as illustrated in FIG. 7 and access the taskbar 706 as before. The taskbar 706 may also be accessed when an application 112 is output in the immersive shell 604, when in a desktop shell 606, and so on. Accordingly, the expanded representations may leverage this accessibility to support a variety of functionality, including the preview functionality previously described. The expanded representation 706 of FIG. 7, for instance, includes functionality that may be used to preview content associated with the represented application 112, further discussion of which is described as follows and shown in a corresponding figure.

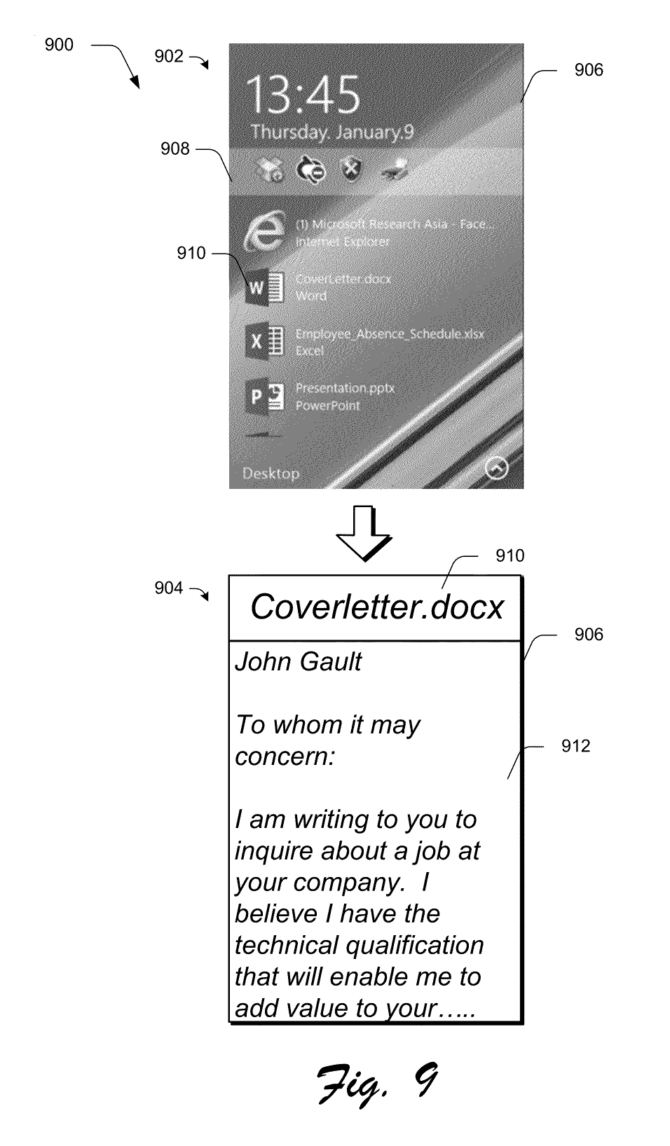

FIG. 8 is an example implementation 800 showing the expanded representation 708 of FIG. 7 in greater detail. The expanded representation 708 in this example corresponds to a music application and includes content of music that is accessible via the represented application (e.g., the third display mode) as well as via the “portal” provided by the expanded representation. For example, the expanded representation 708 includes a preview 802 with which a user may interact to output music. The preview 802 includes album art along with a user interface that is configured to control output of the music by the computing device 102. The expanded representation 708 also includes other content 804 (e.g., songs) that is selectable for output as a preview 802.

Although a music application is shown in the expanded application representation 708, it is to be appreciated that any suitable application type with content expanded view, and/or limited functionality expanded application representation may be used in the embodiment of the task bar in addition to or alternative to application representations in the root level display. This portal of the task bar 706 of FIG. 7 with expandable application representations may thus support non-modal interaction to the content included in the expanded representation, which may be leveraged to support a variety of different functionality. A variety of other previews are also contemplated, an example of which is described in the following and shown in a corresponding figure.

FIG. 9 depicts an example implementation 900 of an expanded representation of the desktop shell 606 of FIG. 6. This example is also illustrated using first and second stages 902, 904. At the first stage 902, the expanded representation 906 as previously described treats the desktop shell 606 as an application. Accordingly, the expanded representation 906 of the desktop shell is configured to include content associated with the desktop shell.

In the illustrated example, this content describes applications 112 that are “open” within the desktop shell 606, which include a browser, word processing application, spreadsheet application, and presentation application. Each of the content items are selectable to navigate directly to a corresponding application within the desktop shell 606 from the root level display. Although running applications may be displayed in the desktop application representation as shown in FIG. 9, any suitable number and or types of states of applications may be shown in the desktop application representation such as a most frequently used list of application, applications pinned in the a desktop application representation by the user, any or all of which may be shown in the an first or further hierarchical expanded view of the desktop application representation in the root mode display.

The expanded representation 906 may include icons 908 received from a taskbar of the desktop shell 606, which include a file sharing application, antivirus utility, and a representation of a printer which are also selectable to navigate to corresponding functionality within the desktop shell 606. Thus, the expanded representation 906 may operate as a portal (e.g., a “wormhole”) between the shells of the operating system 110 by supporting interaction between the shells without requiring output of both shells. This interaction may include use of preview functionality as previously described.

For example, a user may select content 910 via a hover gesture, use of a cursor control device, and so on as previously described to cause output of the preview 912 of the content 910, an example of which is shown in the second stage 904. The content 904 in this example is a cover letter and thus a corresponding application 112 configured as a word processor is utilized to output the cover letter in the expanded representation 906. Thus, in this example the preview 912 provides not only a portal between shells but also applications 112 that are executable within those shells.

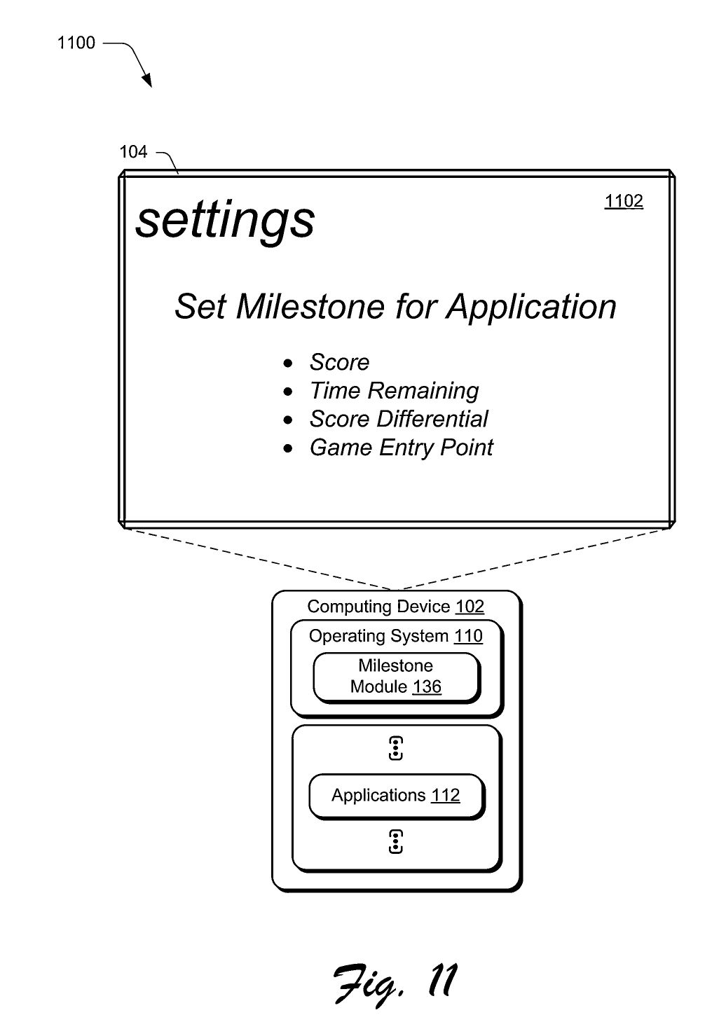

FIG. 10 is an example implementation 1000 showing representations and expanded representations of news and contacts applications that are usable to display previews. The news application may have a representation 1002 configured for display in the first display mode as above. The representation 1002 may then be expanded to display an expanded representation 1004 that includes content related to the news application, which in this instance is displayed as headlines and corresponding images.

As previously described, navigation between the representation 1002 and the expanded representation 1004 may be performed responsive to a user input, e.g., a cursor control device, gesture, spoken command, and so forth. Other implementations are also contemplated in which the transition from the representation 1002 to the expanded representation 1004 may be performed automatically and without user intervention. In this example, a milestone involving a notification may be received by the notification module 122 of subject matter flagged by a user, subject matter flagged by a provider of the notification, and so on. Responsive to this milestone (e.g., an Amber alert), the representation 1002 may be expanded to form the expanded representation 1004 to provide addition information related to the notification. A variety of other examples are also contemplated as further described in relation to FIG. 11. Further expansions may be activated and displayed to provide limited functionality such as search, filter, display of articles, and so forth.

The contact application representation may be further expanded to allow limited functionality. The expansion may be in a horizontal or vertical direction. For example, in some aspects, the application representation may be expanded in the vertical direction to display a text entry area for response to a message and/or expand to left to include an activation icon to initiate a call with the associated contact. These are just two examples of limited functionality or interaction with a contracts application and any suitable expansions of the representation and/or subset and limited set of functionality may be used as appropriate.

For the representation 1006 of the contact application, for instance, a user may indicate particular contacts that are to cause an automatic display of the expanded representation 1008, particular posted content in a shared network resource (e.g., a social network service), and so on. Similarly, a sender of a notification may include an urgency milestone for a particular communication (voicemail, text, email, etc.) that may additionally or alternatively be used by the operating system 108 to trigger an automatic display of the expanded representation. Receipt of corresponding notifications by the notification module 114 may then also cause automatic display of the expanded representation 1008.

The expanded representations 1004, 1008 may also be configured to support preview functionality. For example, for the expanded representation 1004 for the news a news video clip may be output within the representation. Likewise for the expanded representation 1008 for the contact application a user may preview content posted to a shared network resource, such as a social network service. Thus, as previously described the expanded representations may provide a non-modal portal into content available via the respective applications.

FIG. 11 depicts a system 1100 in an example implementation in which the milestone module 136 outputs a user interface configured to accept user inputs to set milestones for applications 112. The user interface 1102 in this example involves settings maintained by the operating system 110 although other examples are also contemplated, such as to set milestones through the applications 112 themselves.

The user interface 1102 is configured to receive user inputs to set milestones to cause output of applications 112 in the user interface 1102. This may include setting a milestone regarding a score (e.g., either real or in a game), an amount of time remaining, score differential, a game entry point, and so on for an event that is either “real” (e.g., an actual sporting event) or results from execution of the applications 112, e.g., a video game. Other milestones are also contemplated, such as a number of “likes” or comments for a post to a social network service, a number of views of an image in a photo sharing network service, a number of times a post has been forwarded, and so on. An example of use of a milestone is described as follows and shown in a corresponding figure.

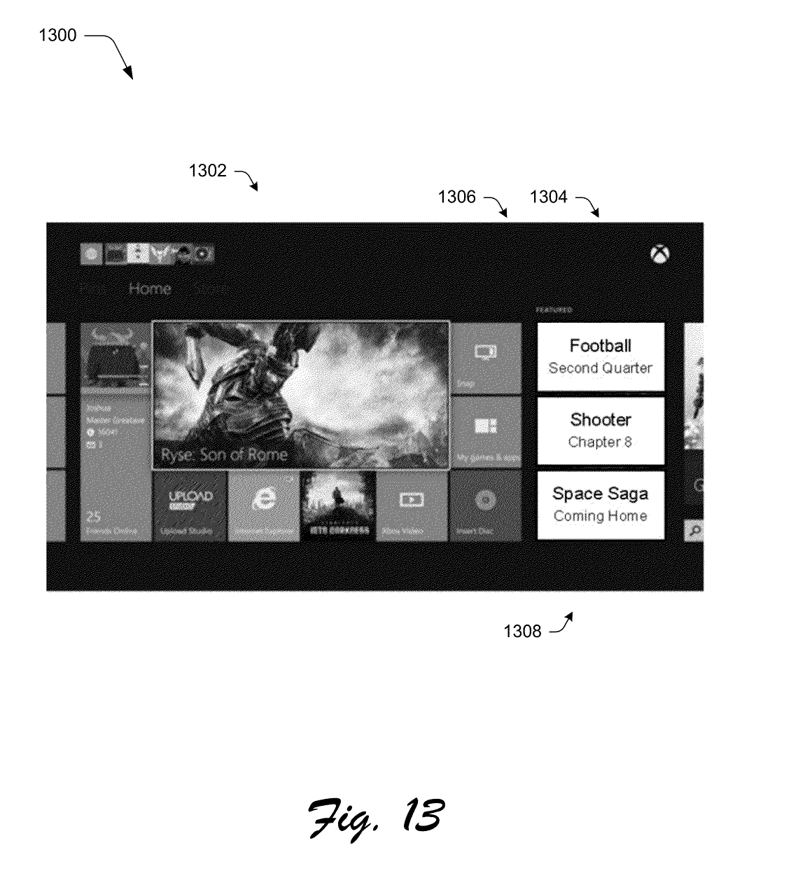

FIG. 12 depicts an example implementation 1200 in which a predefined milestone is detected to cause output of an application. This example implementation is shown using first and second stages 1202, 1204. At the first stage 1202, a user interface 1206 is output by the computing device 102 and displayed by the display device 104. The user interface 1206 may be configured in a variety of ways, such as to output live or recorded broadcast television, productivity applications, games, and so on.

During this output, the milestone module 122 may detect occurrence of a milestone specified by a user through interaction with the user interface 1102 of FIG. 11. In this example, the milestone relates to a sporting event, e.g., score differential, time remaining, and so forth. The detection of the milestone may be performed in a variety of ways, such as through execution of the application itself (e.g., in the background), through use of the notifications as described in FIG. 1 such that the application is not executed (e.g., by registering for notifications), and so forth.

Once detected, a display of the application corresponding to the milestone is launched. A variety of different display techniques may be utilized. As illustrated at the second stage 1204, for instance, the display 1208 of the application relating to the milestone may be placed in a primary view with a concurrent view of the user interface 1206 of what the user was previously interacting with placed in an expanded representation.

In another example, the application relating to the milestone is output as an expanded representation (e.g., as part of a taskbar that is output automatically) and the previous user interface is placed in a primary portion of the display. Other examples are also contemplated, e.g., a primary portion with a “snapped” portion that has a display size that is smaller than the primary portion, display in a full screen (e.g., immersive shell) that replaces a previous user interface, and so forth.

Additionally, in one or more implementations a user may specify how this display is to occur as part of specifying the milestone. In this way, a user may specify what is to occur to generate an interruption with another application and how this interruption is to occur.

A variety of other examples are also contemplated, such as a multiplayer game example in which a user may specify that when they “die” in the game the user interface may be automatically output again once a point is reached where the user may return to the game, e.g., when the game is over, substituted for another player, and so on. These milestones may also leverage the expanded representation techniques in other ways, an example of which is described as follows and shown in a corresponding figure.

FIG. 13 depicts an example implementation 1300 in which milestone expanded representations are utilized to represent particular points in time and include previews for a game that are selectable to launch the game at the previewed point in time. A user interface 1302 is configured as a start screen as previously described. The start screen includes representations of application in a first display mode as previously described that are selectable to launch execution of the applications, may include notifications, and so on.

The user interface 1302 also includes expanded representations 1304, 1306, 1308 that represent milestones in games in this example but other applications are also contemplated. This may include milestones set by a user as described in FIG. 11 or other “save points” in interaction with the respective application. These expanded representations 1304, 1306, 1308 may also include preview functionality such that a preview may be provided as previously described, such as to give a user context as far as “what part” in the output of the content is represented by the expanded representation. Other examples are also contemplated without departing from the spirit and scope thereof

FIG. 14 depicts an example implementation 1400 in which a storyline is linked between a plurality of applications. This example is also illustrated using first and second stages 1402, 1404. At the first stage 1402, a user interface 1406 is output that is a root file of a file system. The user interface 1406 is usable to launch applications as previously described. In the first stage 1402, a user selects a representation 1408 of an application, which in this instance is a version of a football game, e.g., “Football 2014.” The input, for instance, may be detected by the computing device 102 via a NUI input device 118, use of a control 114, speech command, and so on.

In response to this input, the computing device 102 may begin loading the application 112, e.g., a game in this instance which is shown illustrated in a primary portion 1408 of the display device 104 at the second stage 1404. During the loading of the game 1408, a previous version of the game is also displayed concurrently, which in this instance leverages use of an expandable representation 1410 in a taskbar.

Thus, in this instance the output of the previous version of the game may be utilized to give context to “what is being loaded” for the subsequent version. For example, the subsequent version may involve a continuation of a plot point and thus the previous version of the application may be output during this loading to provide the context. In this way, a storyline may be continued across a plurality of different applications. A variety of other examples are also contemplated, further discussion of which may be found in relation to the following procedures.

Example Procedures

The following discussion describes expandable application representation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the example environment.

FIG. 15 depicts a procedure 1500 in an example implementation in which a representation is expanded in a root level of a file hierarchy of an operating system and used to provide a preview. Representations are output of applications in a root level of a file hierarchy maintained by an operating system of the computing device, the representations selectable to launch execution of respective applications (block 1502). The representations, for instance, may be displayed in a first display mode that is configured to output notifications within the representations and without execution of the represented application, e.g., through leveraging the notification system of FIG. 1.

Responsive to recognition by the operating system of an input configured to cause expansion of one of the representations, a display is expanded of the representation for inclusion in the root level with one or more other representations, the expanded display of the representation configured to accept one or more inputs for a respective application (block 1504). A user, for instance, may make a gesture that is recognized by the operating system 110 to cause expansion of a representation displayed in the first display mode to an expanded display in the second display mode. When in the second display mode, inputs may be received to interact with content included within the expanded representation, such as to select a photo, input text, print a document, and so forth.

The expanded display may also cause rearrangement of one or more other ones of the representations in the root level in the grid layout that maintains the grid layout. Continuing with the previous example, receipt of the input may cause both expansion of the representation as well as rearrangement of other representations as shown in FIG. 3.

Responsive to recognition by the operating system of an input configured to display a preview of content associated with the expanded representation, the preview of the content is displayed within the expanded display of the representation (block 1506). This may include a preview of video as shown in FIGS. 4 and 5, of music as shown in FIGS. 7 and 8, shells and content accessible via the shells as shown in FIG. 9, news and contacts as shown in FIG. 10, and so forth.

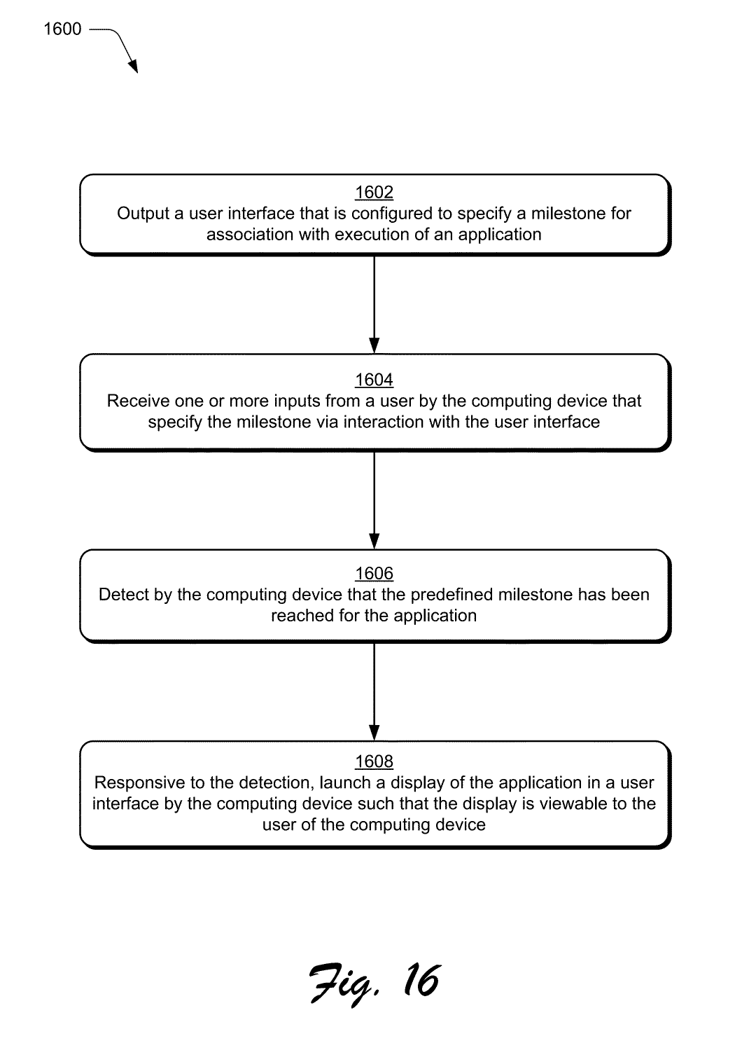

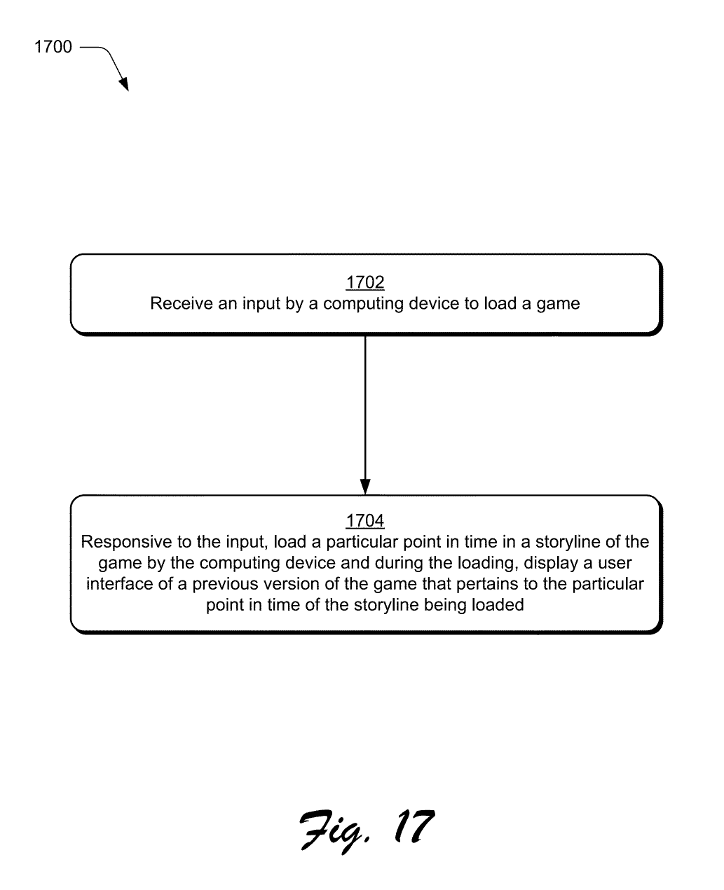

FIG. 16 depicts a procedure 1600 in an example implementation in which a milestone is defined by a user and utilized to control output of an application. A user interface is output that is configured to specify a milestone for associate with execution of an application (block 1602). A user, for instance, may interact with a settings screen of the operating system 110 to set the milestone. The milestone may leverage notifications 124 as previously described such that the reaching of the milestone may be detected without executing a corresponding application 112. Other examples of direct interaction with the applications 112 are also contemplated to specify the milestones.

One or more inputs are received from a user by the computing device that specify the milestone via interaction with the user interface (block 1604). Continuing with the previous example, the user may specify parameters with a predefined milestone (e.g., score of a game), create a milestone of their own through interaction with the user interface, and so on.

The computing device detects that the predefined milestone has been reached for the application (block 1606). The computing device 102 may then detect whether the milestone has been reached, such as to analyze registered for notifications 124 received from a web service 130, through execution of the applications 112, and so forth.

Response to the detection, a display of the application is launched in a user interface by the computing device such that the display is viewable to the user of the computing device (block 1608). The display may be performed using a full screen view, an expanded representation, a snapped configuration, and so on as previously described.

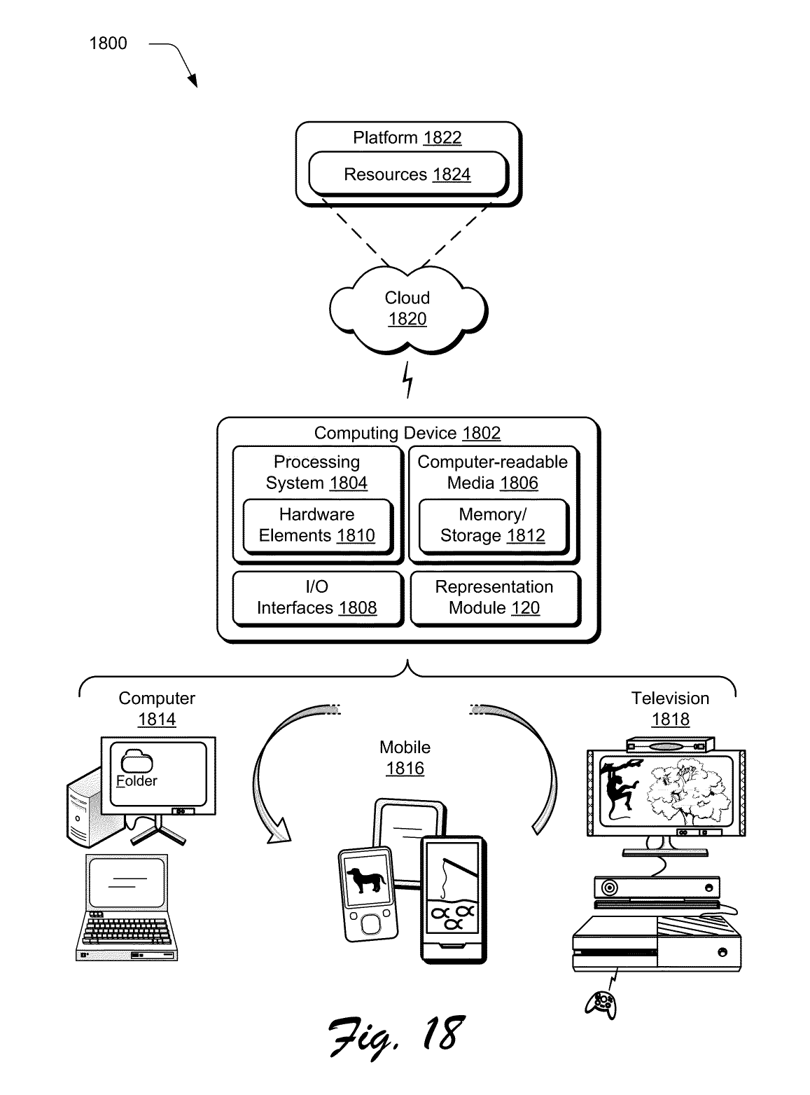

FIG. 17 depicts a procedure 1700 in an example implementation in which a link of a storyline between a plurality of applications is leveraged in loading at least one of the applications. An input is received by a computing device to load a game (block 1702). A user, for instance, may interact with a start screen as shown in the first stage 1402 to select a representation of the game, such as via a gesture detected using the NUI input device 118, use of a controller 116, a keyboard, speech input, and so on.

Responsive to the input, a particular point in time in a storyline of the game is loaded by the computing device and during the loading, a user interface of a previous version of the game is displayed that pertains to the particular point in time of the storyline being loaded (block 1704). Continuing with the previous example, the selected game may begin loading, which may take a significant amount of time for feature rich games. This time may be leveraged to show a connection in a storyline in the game being loaded with previous versions of the game, e.g., continuation of plot points and so on. In this way, a storyline may continue between versions of a game giving the user a unified experience. Other examples are also contemplated without departing from the spirit and scope thereof.

Example System and Device

FIG. 18 illustrates an example system generally at 1800 that includes an example computing device 1802 that is representative of one or more computing systems and/or devices that may implement the various techniques described herein, which is illustrated through inclusion of the representation module 120. The computing device 1802 may be, for example, a server of a service provider, a device associated with a client (e.g., a client device), an on-chip system, and/or any other suitable computing device or computing system.

The example computing device 1802 as illustrated includes a processing system 1804, one or more computer-readable media 1806, and one or more I/O interface 1808 that are communicatively coupled, one to another. Although not shown, the computing device 1802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1804 is representative of functionality to perform one or more operations using hardware. Accordingly, the processing system 1804 is illustrated as including hardware element 1810 that may be configured as processors, functional blocks, and so forth. This may include implementation in hardware as an application specific integrated circuit or other logic device formed using one or more semiconductors. The hardware elements 1810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1806 is illustrated as including memory/storage 1812. The memory/storage 1812 represents memory/storage capacity associated with one or more computer-readable media. The memory/storage component 1812 may include volatile media (such as random access memory (RAM)) and/or nonvolatile media (such as read only memory (ROM), Flash memory, optical disks, magnetic disks, and so forth). The memory/storage component 1812 may include fixed media (e.g., RAM, ROM, a fixed hard drive, and so on) as well as removable media (e.g., Flash memory, a removable hard drive, an optical disc, and so forth). The computer-readable media 1806 may be configured in a variety of other ways as further described below.

Input/output interface(s) 1808 are representative of functionality to allow a user to enter commands and information to computing device 1802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1810 and computer-readable media 1806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1810. The computing device 1802 may be configured to implement particular instructions and/or functions corresponding to the software and/or hardware modules. Accordingly, implementation of a module that is executable by the computing device 1802 as software may be achieved at least partially in hardware, e.g., through use of computer-readable storage media and/or hardware elements 1810 of the processing system 1804. The instructions and/or functions may be executable/operable by one or more articles of manufacture (for example, one or more computing devices 1802 and/or processing systems 1804) to implement techniques, modules, and examples described herein.

As further illustrated in FIG. 18, the example system 1800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1802 may assume a variety of different configurations, such as for computer 1814, mobile 1816, and television 1818 uses. Each of these configurations includes devices that may have generally different constructs and capabilities, and thus the computing device 1802 may be configured according to one or more of the different device classes. For instance, the computing device 1802 may be implemented as the computer 1814 class of a device that includes a personal computer, desktop computer, a multi-screen computer, laptop computer, netbook, and so on.

The computing device 1802 may also be implemented as the mobile 1816 class of device that includes mobile devices, such as a mobile phone, portable music player, portable gaming device, a tablet computer, a multi-screen computer, and so on. The computing device 1802 may also be implemented as the television 1818 class of device that includes devices having or connected to generally larger screens in casual viewing environments. These devices include televisions, set-top boxes, gaming consoles, and so on.

The techniques described herein may be supported by these various configurations of the computing device 1802 and are not limited to the specific examples of the techniques described herein. This functionality may also be implemented all or in part through use of a distributed system, such as over a “cloud” 1820 via a platform 1822 as described below.

The cloud 1820 includes and/or is representative of a platform 1822 for resources 1824. The platform 1822 abstracts underlying functionality of hardware (e.g., servers) and software resources of the cloud 1820. The resources 1824 may include applications and/or data that can be utilized while computer processing is executed on servers that are remote from the computing device 1802. Resources 1824 can also include services provided over the Internet and/or through a subscriber network, such as a cellular or Wi-Fi network.

The platform 1822 may abstract resources and functions to connect the computing device 1802 with other computing devices. The platform 1822 may also serve to abstract scaling of resources to provide a corresponding level of scale to encountered demand for the resources 1824 that are implemented via the platform 1822. Accordingly, in an interconnected device embodiment, implementation of functionality described herein may be distributed throughout the system 1800. For example, the functionality may be implemented in part on the computing device 1802 as well as via the platform 1822 that abstracts the functionality of the cloud 1820.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device, the method comprising:
outputting representations of applications in a root level of a file hierarchy maintained by an operating system of the computing device, the representations selectable to launch execution of respective said applications;
responsive to recognition by the operating system of an input configured to cause expansion of one of the representations, expanding a display of the representation for inclusion in the root level with one or more other said representations; and
responsive to recognition by the operating system of an input configured to display a preview of content associated with the expanded representation, displaying the preview of the content within the expanded display of the representation.

2. A method as described in claim 1, wherein the preview involves a milestone of a game that is subject of execution of the respective said application.

3. A method as described in claim 2, further comprising responsive to recognition of an input made in relation to the expanded representation to launch the respective said application, launching the respective said application to output the game at the milestone.

4. A method as described in claim 3, wherein the launching of the respective said application causes output of the game in an immersive shell.

5. A method as described in claim 1, wherein the content represented within the expanded display is consumable as part of execution of the respective said application.

6. A method as described in claim 1, wherein the representations of the applications are configured to output notifications as part of the respective said applications without executing the respective said applications.

7. A method as described in claim 1, wherein the expanding the display of the representation includes use of an animation showing a successively expanding transition from the representation to the expanded representation within the root level.

8. A method as described in claim 1, further comprising responsive to recognition by the operating system of an input configured to cause the expanded representation to be included in a taskbar, including the expanded representation for display as part of the taskbar.

9. A method comprising:
outputting a user interface that is configured to specify a milestone for association with execution of an application;
receiving one or more inputs from a user by the computing device that specify the milestone via interaction with the user interface;
detecting by the computing device that the predefined milestone has been reached for the application;
responsive to the detecting, launching a display of the application in a user interface by the computing device such that the display is viewable to the user of the computing device.

10. A method as described in claim 9, wherein the launching of the display causes an expanded representation of the application to be displayed in a root level of a file hierarchy of the computing device along with representations of other applications that are selectable to launch the other applications, respectively.

11. A method as described in claim 9, wherein the launching of the display causes an expanded representation of the application to be displayed in a taskbar of the computing device.

12. A method as described in claim 9, wherein the launching of the display replaces a display of a user interface of another application.

13. A method as described in claim 9, wherein the launching of the display of the application causes a concurrent display with a user interface of another application.

14. A method as described in claim 9, wherein the milestone is a sports score or amount of time left in a sporting event.

15. A method as described in claim 9, wherein the milestone is an entry point of a game.

16. A method as described in claim 15, wherein the game is a multiplayer game that is accessible to a plurality of users via a web service.

17. A method as described in claim 9, wherein the launching of the display of the application results in an output of broadcast content.

18. A method comprising:
receiving an input by a computing device to load a game;
responsive to the input:
loading a particular point in time in a storyline of the game by the computing device; and
during the loading, displaying a user interface of a previous version of the game that pertains to the particular point in time being loaded.

19. A method as described in claim 18, wherein the user interface of the previous version of the game is displayed in an expanded representation of the game.

20. A method as described in claim 18, wherein the user interface of the previous version of the game is displayed in a taskbar.
